(19) United States
(12) Patent Application Publication
(10) Pub. No.: US 2004/0117672 A1
(43) Pub. Date: Jun. 17, 2004

(54) Method and apparatus for computer timing shutdown

(76) Inventor: Jamson Lin, Taipei (TW)

Correspondence Address: BIRCH STEWART KOLASCH & BIRCH, PO BOX 747, FALLS CHURCH, VA, 22040-0747, US

(21) Appl. No.: 10/319,634

(22) Filed: Dec. 16, 2002

(51) Int. Cl. G06F 1/26

(52) U.S. Cl. 713/300

(57) ABSTRACT

A method and apparatus for computer timing shutdown includes a computer host, an external control unit and an activation unit connecting to the computer host and the external control unit. A key element is provided to insert into the activation unit to activate the activation unit 3 and set allowable computer use time. When the key element is removed from the activation unit, the computer host enters a timing mode. When the actual use time exceeds the set allowable use time, the computer host is shut down automatically.

### FIELD OF THE INVENTION

The present invention relates to a method and apparatus for computer timing shutdown and particularly an apparatus and method for setting use time of a computer host.

### BACKGROUND OF THE INVENTION

In the information age we are living today many children have accessed computers at very young age. Although the computer brings children a vast imaginative space and provides an interesting learning environment, its convenience also has some negative side effects. For instance, their lack of discipline and self control often make them difficult to resist the temptation of computer games. As a result, many children often indulge themselves in the virtual network world. This has adverse impact to their personality development and deprives their chances of participating outdoor activities. In addition, there are reports indicating that children who indulge in the virtual world have a lower adaptability to the real world environment, and tend to have abnormal personality.

To remedy the problems and concerns mentioned above, some vendors have designed a computer power supply lock that can shut down the internal circuit of the computer to disable the computer so that children cannot start the computer unless authorized. However, to restrict or prohibit the children from using the computer in such an extreme is not healthy. As the computer has become an essential tool for children living in the modern world, to help the children to use the computer smartly is very important for preparing them to live and work well in the future.

### SUMMARY OF THE INVENTION

Therefore the primary object of the invention is to resolve the aforesaid disadvantages. The invention provides a hardware and a software that can be coupled to limit computer use time.

In order to achieve the foregoing object, the apparatus for computer timing shutdown of the invention includes a computer host, an external control unit and an activation unit connecting to the computer host and the external control unit, or merely connecting to the computer host. A key element is provided to insert into the activation unit to set allowable computer use time. Once the key element is removed from the activation unit, the computer host enters a timing mode. When the actual use time exceeds the set allowable use time, the computer is shut down automatically.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention.

FIG. 2 is a schematic view of another embodiment of the invention.

FIG. 3 is a software control flow chart of the invention.

### DESCRIPTION OF THE PREFERRED EMBODIMENTS

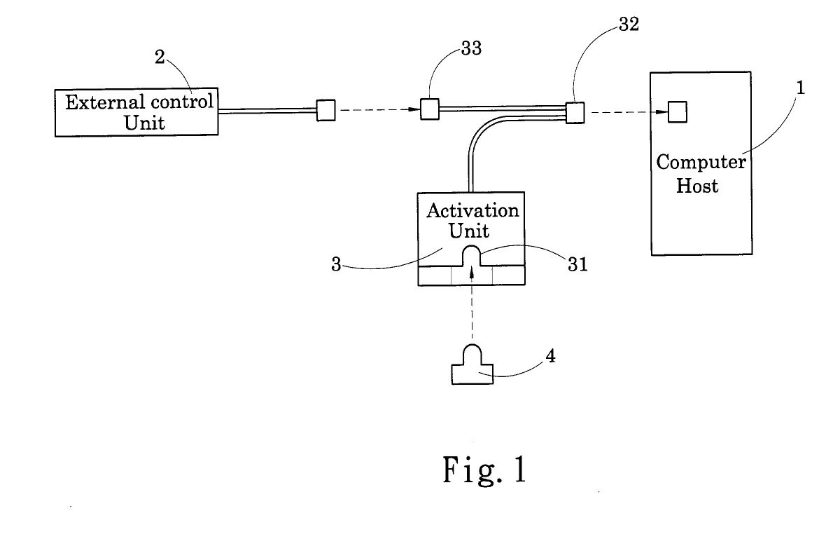

Referring to FIG. 1, the apparatus for computer timing shutdown of the invention includes a computer host 1, an external control unit 2 and an activation unit 3 connecting to the computer host 1 and the external control unit 2. A key element 4 is provided to insert into the activation unit 3 to activate the activation unit 3 and set allowable use time of the computer host 1.

The external control unit 2 is to output operation commands into the computer host 1. It may be a keyboard, keypad, mouse, joy stick or the like.

The activation unit 3 has a key way 31 for receiving the key element 4 to activate the activation unit 3. The activation unit 3 further has connectors 32 and 33 for connecting to the computer host 1 and the external control unit 2. The connectors may be interfaces such as DB, PS2, USB, or the like.

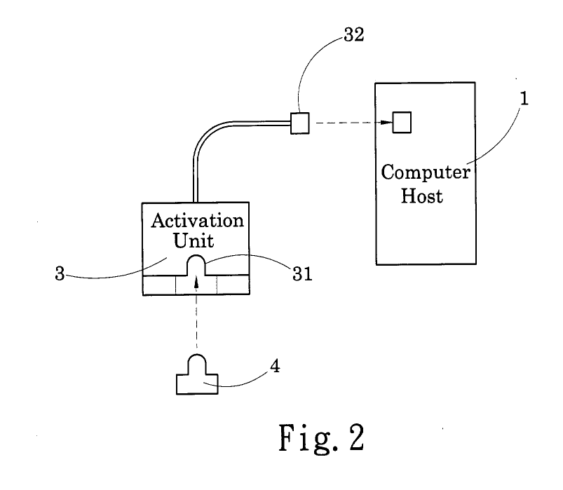

When the key element 4 is inserted into the activation unit 3, the allowable use time of the computer host 1 may be set. When the key element 4 is removed from the activation unit 3, the computer host enters a timing mode. When the actual use time exceeds the set allowable use time, the computer host automatically shuts down. Refer to FIG. 2 for another embodiment of the invention. In this embodiment, the activation unit 3 connects only to the computer host 1. The connector 32 may be an interface such as DB, PS2, USB, or the like.

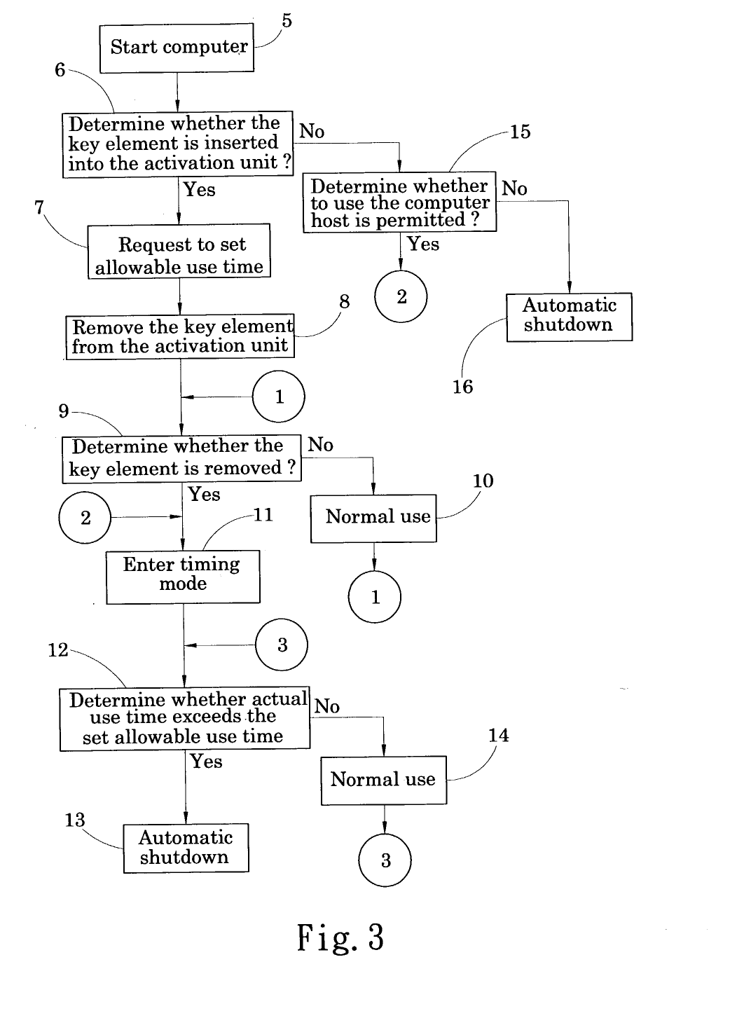

Refer to FIG. 3 for the software control flow according to the invention. The method for computer timing shutdown of the invention includes the following steps: starting the computer 5; determining whether the key element is inserted in the activation unit 6; if the outcome is positive, requesting to set the use time 7; after the use time is set, removing the key element from the activation unit 8; determining whether the key element has been removed 9; if the outcome is negative, entering a normal use condition 10; repeating determining whether the key element has been removed 9; if the outcome is positive, entering the timing mode 11, and determining whether the actual use time exceeds the set allowable use time 12; if the outcome is positive, shutting down the computer automatically 13; if the outcome is negative, entering the normal use 14, and repeating determining whether the actual use time exceeds the set allowable use time 12.

In the foregoing processes, at the step of determining whether the key element is inserted in the activation unit 6, if the outcome is negative (i.e. no key is inserted), determining whether to use the computer host is permitted 15; if the outcome is negative, shutting down the computer automatically 16; if the outcome is positive, entering the timing mode 11; then determining whether the actual use time exceeds the set allowable use time 12; if the outcome is positive, shutting down the computer automatically 13; if the outcome is negative, entering the normal use 14, and repeating determining whether the actual use time exceeds the set allowable use time 12.

What is claimed is:

1. An apparatus for computer timing shutdown to set allowable use time for a computer host, comprising:
an external control unit for outputting operation commands into the computer host; and
an activation unit connecting to the computer host and the external control unit and receiving a key element for activating to set the use time of the computer host, the computer host entering a timing mode when the key element is removed from the activation unit, and the computer host being shut down automatically when actual use time exceeding the set allowable use time.

2. The apparatus for computer timing shutdown of claim 1, wherein the external control unit is a keyboard.

3. The apparatus for computer timing shutdown of claim 1, wherein the external control unit is a keypad.

4. The apparatus for computer timing shutdown of claim 1, wherein the external control unit is a mouse.

5. The apparatus for computer timing shutdown of claim 1, wherein the external control unit is a joystick.

6. The apparatus for computer timing shutdown of claim 1, wherein the activation unit has PS2 interface connectors to connect to the external control unit and the computer host.

7. The apparatus for computer timing shutdown of claim 1, wherein the activation unit has DB series connectors to connect to the external control unit and the computer host.

8. The apparatus for computer timing shutdown of claim 1, wherein the activation unit has USB connectors to connect to the external control unit and the computer host.

9. The apparatus for computer timing shutdown of claim 1, wherein the key element is an IC card.

10. The apparatus for computer timing shutdown of claim 1, wherein the activation unit connects only to the computer host.

11. A method for computer timing shutdown to set allowable use time for a computer host, comprising:
a. starting the computer host;
b. determining whether a key element is inserted in an activation unit, requesting to set allowable use time when the key element is inserted in the activation unit;
c. removing the key element from the activation unit after the use time is set;
d. determining whether the key element is removed, entering a normal use condition if the key element is not removed, and repeating the determining whether the key element is removed; entering a timing mode when the key element is removed;
e. entering the timing mode and determining whether actual use time exceeds the set allowable use time; automatically shutting down the computer host when the actual use time exceeds the set allowable use time; entering the normal use condition when the actual use time does not exceed the set allowable use time; repeating the determining whether actual use time exceeds the set allowable use time;
f. determining whether to use the computer host is permitted when the determining whether the key element is inserted in the activation unit has a negative outcome; automatically shutting down the computer host when the determining whether to use the computer host is permitted has a negative outcome; entering the timing mode when the determining whether to use the computer host is permitted has a positive outcome;
g. determining whether the actual use time exceeds the set allowable use time after having entered the timing mode; automatically shutting down the computer host when the actual use time exceeds the set allowable use time; entering the normal use condition when the actual use time does not exceed the set allowable use time; repeating the determining whether actual use time exceeds the set allowable use time
